(19) United States
(12) Patent Application Publication
(10) Pub. No.: US 2025/0324311 A1
(43) Pub. Date: Oct. 16, 2025

(54) SHORT-CODE SATELLITE POSITIONING SIGNAL USE

(71) Applicant: QUALCOMM Incorporated, San Diego, CA (US)

(72) Inventors: Jordan COOKMAN, San Jose, CA (US); Mangesh CHANSARKAR, Irvine, CA (US); Krishnaranjan RAO, Sunnyvale, CA (US)

(21) Appl. No.: 19/081,050

(22) Filed: Mar. 17, 2025

Related U.S. Application Data
(60) Provisional application No. 63/634,253, filed on Apr. 15, 2024.

(51) Int. Cl. H04W 24/10; H04B 17/318; H04W 52/02; H04W 64/00

(52) U.S. Cl. CPC H04W 24/10; H04B 17/318; H04W 52/0274; H04W 64/00

(57) ABSTRACT

A method of using at least an attempt to measure a short-code-phase signal includes: listening, at an apparatus, for a first signal from a first signal source to determine a first measurement result, the first signal having a first code sequence that is shorter than a second code sequence of a second signal from the first signal source; and determining, at the apparatus and based on the first measurement result, at least one of a signal environment of the apparatus, an indication of time, a Doppler shift of the first signal, whether a first phase of the first signal is consistent with a second phase of the second signal, and a combination of the first measurement result and a second measurement result that comprises a measurement of the second signal.

### CROSS-REFERENCE TO RELATED APPLICATIONS

This application claims the benefit of U.S. Provisional Application No. 63/634,253, filed Apr. 15, 2024, entitled “SHORT-CODE SATELLITE POSITIONING SYSTEM SIGNAL USE,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax®), a fifth-generation (5G) service (e.g., 5G New Radio (NR)), etc., with a sixth-generation (6G) service in development. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard.

Furthermore, signaling efficiencies should be enhanced and latency should be substantially reduced compared to current standards.

Positions of devices, such as mobile devices, may be determined using terrestrial-based positioning signals and/or non-terrestrial network (NTN) signals such as satellite positioning signals and/or positioning signals from aerial vehicles, etc. Satellite positioning system receivers may be included in various devices for detecting and measuring satellite positioning signals. Measurements of the satellite positioning signals may be processed to determine position information, such as ranges between satellites and the receiver and/or a position estimate for the receiver.

Some wireless communication systems facilitate position determination. For example, in Satellite Positioning Systems (SPS), an SPS transmitter (for example, a satellite) may broadcast, from a known location, a pseudo-random noise (PRN) code that is modulated using an SPS carrier wave. Particular examples of SPS wireless technologies may include, for example, the Global Positioning System (GPS), the Global Navigation Satellite System (GLONASS), etc.

An SPS receiver may receive the PRN code from one or more SPS transmitters. The broadcast of the PRN code from the SPS transmitter may have a known start time and the PRN code may repeat after a known period length. Accordingly, the mobile device may receive the broadcast and obtain a time-of-flight (TOF) measurement. The SPS receiver generates a local version of the PRN code having the same symbol sequence and start time as the PRN code broadcast by the SPS transmitter. The SPS receiver receives the PRN code broadcast by the SPS transmitter and compares the received version of the PRN code to the local version of the PRN code. The SPS receiver may detect the presence of the signal and determine a code-phase of the received PRN code by evaluating the amount of delay between the time that the local PRN code is generated and the time that the received PRN code is received. A larger code-phase indicates a longer TOF and a greater distance from the SPS transmitter to the SPS receiver. The calculated distance from a particular SPS transmitter may be referred to as a pseudorange. Multiple pseudoranges may be used to trilaterate and identify a position of the SPS receiver.

SPS signals are DSSS (Direct Sequence Spread Spectrum) signals and carry low data-rate messages to provide almanac and ephemeris information to enable an SPS receiver to know the satellite position at a given time.

### SUMMARY

An example method of using at least an attempt to measure a short-code-phase signal includes: listening, at an apparatus, for a first signal from a first signal source to determine a first measurement result, the first signal having a first code sequence that is shorter than a second code sequence of a second signal from the first signal source; and determining, at the apparatus and based on the first measurement result, at least one of a signal environment of the apparatus, an indication of time, a Doppler shift of the first signal, whether a first phase of the first signal is consistent with a second phase of the second signal, and a combination of the first measurement result and a second measurement result that comprises a measurement of the second signal.

An example apparatus includes: at least one receiver configured to listen for a first signal from a first signal source, the first signal having a first code sequence that is shorter than a second code sequence of a second signal from the first signal source; and at least one processor communicatively coupled to the at least one receiver and configured to: determine a first measurement result based on the at least one receiver listening for the first signal; and determine, based on the first measurement result, at least one of presence/absence of the first signal, an indication of time, a Doppler shift of the first signal, whether a first phase of the first signal is consistent with a second phase of the second signal, and a combination of the first measurement result and a second measurement result that comprises a measurement of the second signal.

Another example apparatus includes: means for listening for a first signal from a first signal source to determine a first measurement result, the first signal having a first code sequence that is shorter than a second code sequence of a second signal from the first signal source; and means for determining, based on the first measurement result, at least one of a signal environment of the apparatus, an indication of time, a Doppler shift of the first signal, whether a first phase of the first signal is consistent with a second phase of the second signal, and a combination of the first measurement result and a second measurement result that comprises a measurement of the second signal.

An example non-transitory, processor-readable storage medium includes processor-readable instructions to cause at least one processor of an apparatus, in order to use at least an attempt to measure a short-code-phase signal, to: listen for a first signal from a first signal source to determine a first measurement result, the first signal having a first code sequence that is shorter than a second code sequence of a second signal from the first signal source; and determine, based on the first measurement result, at least one of a signal environment of the apparatus, an indication of time, a Doppler shift of the first signal, whether a first phase of the first signal is consistent with a second phase of the second signal, and a combination of the first measurement result and a second measurement result that comprises a measurement of the second signal.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3A is a timing diagram of bits of a signal and polarities of corresponding PRN (Pseudo-Random Noise) code repetitions.

FIG. 3B is a timing and polarity diagram of an example non-inverted long-code PRN code repetition, a corresponding example inverted long-code PRN code repetition, and a short-code PRN code.

FIG. 4 is a frequency band plot of satellite signals and frequencies of the satellite signals.

FIG. 5 is a block diagram of an example mobile device.

FIG. 6 is a block diagram of an example of the mobile device shown in FIG. 5.

FIG. 7 is a block flow diagram of a method of signaling environment detection.

FIG. 8 is a block flow diagram of a method of time maintenance.

FIG. 9 is a block flow diagram of a method of Doppler shift estimation.

FIG. 10 is a block flow diagram of a method of tracking error detection.

FIG. 11 is a block flow diagram of a method of dual signal tracking.

FIG. 12 is a block flow diagram of a method of joint signal tracking.

FIG. 13 is a block flow diagram of a method of using at least an attempt to measure a short-code-phase signal.

### DETAILED DESCRIPTION

Techniques are discussed herein for using short-code signals to perform various non-acquisition functions. For example, a mobile device may listen for a short-code PRN (Pseudo-Random Noise) signal and determine a signaling environment of the mobile device based on whether the short-code signal is detected with adequate quality. The mobile device may wake up a portion of the mobile device from a low-power state to listen for the short-code signal and return to the low-power state if the short-code signal is not detected, e.g., within a threshold time. As another example, a short-code signal may be measured to determine time. As another example, a short-code signal may be measured to determine Doppler shift and this shift used to estimate Doppler shifts of other signal sources, e.g., satellites, and to narrow a frequency search space for acquiring signals from the other signal sources. As another example, short-code and long-code signals from the same signal source may be measured and compared to detect one or more errors corresponding to one or more of the signals. As another example, short-code and long-code signals from the same signal source may be measured and measurement results coherently or non-coherently combined. These are examples, and other examples may be implemented.

Items and/or techniques described herein may provide one or more of the following capabilities, as well as other capabilities not mentioned. A signaling environment, time, and/or Doppler shift may be determined using less power than present techniques. Errors in one or more of multiple signals tracked from the same signal source may be detected. Multiple signals from the same signal source may be tracked with different tracking parameters such that at least one signal may be tracked under a condition where another signal cannot be tracked. Measurement results from measuring multiple signals from the same signal source may be combined to enhance one or more signal measurement properties such as signal-to-noise ratio and/or measurement accuracy. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. In industrial applications, the location of a mobile device may be necessary for asset tracking, robotic control, and other kinematic operations which may require a precise location of an end effector. Existing positioning methods include methods based on measuring radio signals transmitted from a variety of devices or entities including satellite vehicles (SVs) and terrestrial radio sources in a wireless network such as base stations and access points. Stations in a wireless network may be configured to transmit reference signals to enable mobile device to perform positioning measurements. Various positioning methods for a UE are currently defined which can utilize reference signals transmitted by base stations in 4G LTE or 5G NR wireless networks such as Positioning Reference Signals (PRS) and/or Cell-specific Reference Signals (CRS) for position determination.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, automobile, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” a “device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® short-range wireless communication technology networks (e.g., based on IEEE (Institute of Electrical and Electronics Engineers) 802.11, etc.) and so on. Two or more UEs may communicate directly in addition to or instead of passing information to each other through a network.

A base station may operate according to one of several RATs in communication with UEs depending on the network in which it is deployed. Examples of a base station include an Access Point (AP), a Network Node, a NodeB, an evolved NodeB (eNB), or a gNodeB (gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (cMBB), or others) that may provide access for different types of devices. In some examples, the term “cell” may refer to a portion of a geographic coverage area (for example, a sector) over which the logical entity operates.

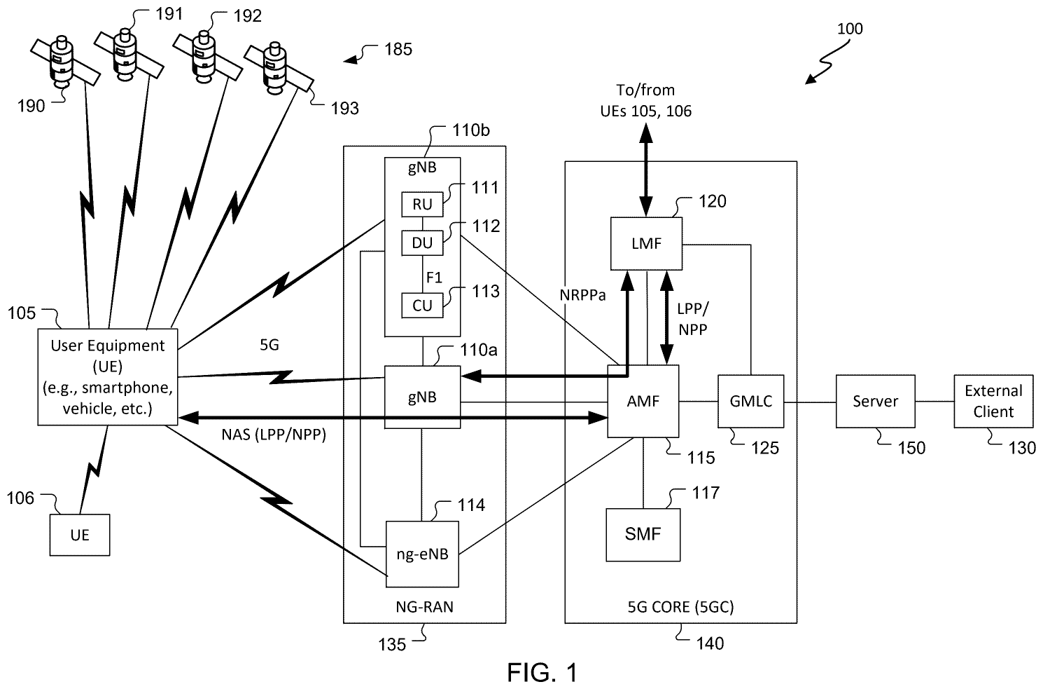

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., a smartphone, an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC has been performed by the Third Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, a future 6G RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193, also referred to as satellites or space vehicles, for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (referred to as gNodeBs or gNBs) 110a, 110b, and a next generation NodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media and data sessions with UEs 105 and 106. Base stations such as the gNBs 110a, 110b and/or the ng-eNB 114 may each support a macro cell (e.g., a high-power cellular base station), or a small cell (e.g., a low-power cellular base station). There may also be access points (not shown in FIG. 1) that may each be a short-range base station configured to communicate with short-range technology such as WiFi® short-range wireless communication technology, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may be replaced by or include various other location server functionality and/or base station functionality respectively.

The system 100 is capable of wireless communication in that components of the system 100 can communicate with one another (at least sometimes using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geodetically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geodetically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect with one or more others UEs (e.g., the UE 106) via one or more device-to-device (D2D) or peer-to-peer (P2P) links, also referred to as sidelink links. The D2D, P2P and sidelink links may be supported with any appropriate sidelink radio access technology (RAT), such as LTE, LTE Direct (LTE-D), NR, WiFi® Direct (WiFi®-D), Bluetooth®, and so on. One or more of a group of UEs utilizing sidelink communication may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via sidelink communications may utilize a one-to-many (1:M) system in which each UE may transmit to other UEs in the group. A TRP may facilitate scheduling of resources for sidelink communications. In other cases, sidelink communication may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-cNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (ELTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may correspond to (e.g., may be supported by) a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA), Downlink (DL) Time Difference of Arrival (TDOA), Uplink (UL) TDOA, Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push a location estimate of the UE 105 to the server 150. In some embodiments, the server 150 may be absent and the external client 130 may interact directly with the GMLC 125 to request and/or receive a location estimate for the UE 105.

The GMLC 125 may support a location request for the UE 105 received from the external client 130 either directly or via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 either directly or via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-NB 114 using a New Radio Position Protocol A (which may be referred to as NRPPa), which may be defined in 3GPP Technical Specification (TS) 38.455. NRPPa messages can be transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 37.355. Here, LPP messages may be transferred between the UE 105 and the LMF 120 via the AMF 115 and the serving gNB 110a, 110b or the serving ng-eNB 114 for the UE 105. For example, LPP messages may be transferred between the LMF 120 and the AMF 115 using service operations based on the Hypertext Transfer Protocol (HTTP), and may be transferred between the AMF 115 and the UE 105 using a 5G Non-Access Stratum (NAS) protocol. The LPP protocol may be used to support positioning of the UE 105 using UE-assisted and/or UE-based position methods such as A-GNSS, RTK, OTDOA, DL-TDOA, AoD and/or E-CID. The NRPPa protocol may be used to support positioning of the UE 105 using network-based position methods such as UL-TDOA or E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP message via the NG-RAN 135 and the 5GC 140.

An LPP message sent from the LMF 120 to the UE 105 may instruct the UE 105 to do any of a variety of things depending on desired functionality. For example, the LPP message could contain an instruction for the UE 105 to obtain measurements for GNSS (or A-GNSS), WLAN, E-CID, OTDOA, DL-TDOA and/or AoD (or some other position method). In the case of E-CID, the LPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such implementations, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi® access for the UE 105 and may comprise one or more WiFi® APs. Here, the N3IWF may connect to the WLAN and to other elements in the 5GC 140 such as the AMF 115. In some examples, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use an LPP annex (LPPa) protocol (e.g., defined in 3GPP TS 36.455) in place of NRPPa to send and receive location information to and from the eNBs in the E-UTRAN and may use LPP to support positioning of the UE 105. In these other examples, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some examples, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

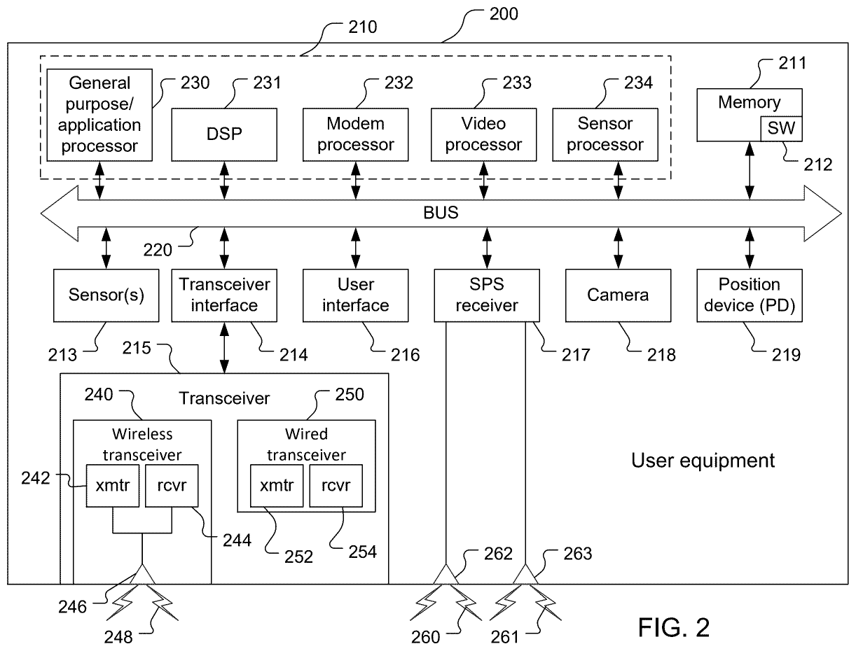

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM

(Subscriber Identity Module or Subscriber Identification Module) may be used by an Original Equipment Manufacturer (OEM), and another SIM may be used by an end user of the UE 200 for connectivity. The memory 211 may be a non-transitory, processor-readable storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes instructions of software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to guided (e.g., wired electrical and/or optical) signals and from guided (e.g., wired electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. New Radio may use mm-wave frequencies and/or sub-6 GHZ frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The SPS receiver 217 (e.g., a Global Positioning System (GPS) receiver) may be capable of receiving and acquiring SPS signals 260, 261 via SPS antenna 262, 263. The SPS antennas 262, 263 are configured to transduce the SPS signals 260, 261 from wireless signals to guided signals, e.g., wired electrical or optical signals, and may be integrated with the antenna 246. The SPS receiver 217 may be configured to process, in whole or in part, the acquired SPS signals 260, 261 for estimating a location of the UE 200. For example, the SPS receiver 217 may be configured to determine location of the UE 200 by trilateration using the SPS signals 260, 261. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260, 261 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, 261, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

### Positioning Techniques

For terrestrial positioning of a UE (e.g., a UE 105) in cellular networks, techniques such as Observed Time Difference Of Arrival (OTDOA), DL-TDOA and AoD often operate in “UE-assisted” mode in which measurements of reference signals (e.g., PRS, CRS, etc.) transmitted by base stations are taken by the UE and then provided to a location server (e.g., LMF 120). The location server calculates the position of the UE based on the measurements and known locations of the base stations. Because these techniques use the location server to calculate the position of the UE, rather than the UE itself, these positioning techniques may not be frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. This assistance data may be encrypted so that only UEs subscribed to the service can directly obtain the information.

In UE-assisted positioning, the UE sends measurements (e.g., TDOA, Angle of Arrival (AoA), etc.) to the positioning server (e.g., LMF/eSMLC). The positioning server may have base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE may use relevant BSA record information (e.g., locations of gNBs (more broadly base stations)) from the network. The BSA information may be encrypted.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is typically larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques already mentioned above include RTT, multi-RTT, OTDOA, DL-TDOA, UL-TDOA, E-CID, DL-AOD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA techniques, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference TRx-Tx (i.e., UE TRx-Tx or UERx-Tx) between the ToA of the RTT measurement signal and the transmission time of the RTT response message in a payload of each RTT response message. The RTT response message would include a reference signal from which the base station can deduce the ToA of the RTT response. By comparing the difference TTx-Rx between the transmission time of the RTT measurement signal from the base station and the ToA of the RTT response at the base station to the UE-reported time difference TRx-Tx, and subtracting the UERx-Tx, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-Positioning FrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of multiple TRPs and the position of the UE 200 based on the ranges to the TRPs and known locations of the TRPs. In UE-assisted RTT, the UE 200 measures positioning signals and provides measurement information to a TRP, and the TRP determines the RTT and range. The TRP provides ranges to a location server and the server determines the location of the UE 200, e.g., based on ranges to different TRPs. The RTT and/or range may be determined by the TRP that received the signal(s) from the UE 200, by this TRP in combination with one or more other devices, e.g., one or more other TRPs and/or a server, or by one or more devices other than the TRP that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence). Position information may include one or more positioning signal measurements (e.g., of one or more satellite signals, of PRS, and/or one or more other signals), and/or one or more values (e.g., one or more ranges (possibly including one or more pseudoranges), and/or one or more position estimates, etc.) based on one or more positioning signal measurements.

Multi-frequency positioning uses positioning signals (e.g., satellite signals, terrestrial network (TN) signals, non-terrestrial network (NTN) signals) from different frequency bands to determine desired information such as pseudoranges between a target device and signal sources, position estimates for the target device, and/or time. Using multi-frequency positioning signals may provide better performance (e.g., position estimate speed and/or accuracy) than using single-frequency positioning signals. For example, using multi-frequency positioning signals may help resolve errors caused by the ionosphere. As another example, using multi-frequency positioning signals may improve performance of high-precision positioning by helping resolve integer ambiguities in carrier-based positioning. As another example, using multi-frequency positioning signals may provide a larger bandwidth that provides better time-of-arrival accuracy. As another example, using multi-frequency positioning signals may provide robustness against jamming (e.g., by switching from a jammed band to an unjammed band). As another example, signals from multiple frequencies may be used to cross check each other for impairments such as multipath or false directions. One or more other performance improvements may also or alternatively be realized. While the discussion herein may focus on SVs as positioning signal sources, the discussion is applicable to other positioning signal sources, e.g., terrestrial-based signal sources and/or other NTN signal sources (e.g., UAVs (unoccupied aerial vehicles)), or combinations of any of such signal sources (i.e., NTN signal sources and/or TN signal sources).

### Short-Code Signal Processing

Positioning as discussed above may be based on acquiring and measuring (e.g., ToA) long-code positioning signals. Long-code positioning signals have code sequences that are sufficiently long, e.g., 10,230 chips for an E5a code vs. 330 for an E5 quasi-pilot (QP) signal, to allow for correlation results with high confidence of accuracy. For example, a 1 ms-long PRN code sequence when correlated with a known sequence corresponding to a particular signal source can yield a time-of-arrival measurement that is both highly accurate and has a high confidence that the positioning signal from the particular signal source was detected. A short-code signal with a short PRN code sequence may be transmitted, by a long-code signal source, in addition to the long-code signal. The short-code signal may be transmitted using the same frequency band as the long-code signal from the same signal source, but has a shorter (possibly much shorter) code sequence (i.e., fewer chips (with each chip being a substantially rectangular pulse in a direct-sequence spread spectrum (DSSS) code) than the code sequence of the long-code signal. The short-code signal has fewer code phase offsets to be searched for correlating a received signal with a known (stored) short-code signal (i.e., a known short-code sequence) to detect the signal, and thus may be acquired much quicker than the long-code signal.

The discussion herein focuses on long-code SPS positioning signals, but the discussion is applicable to other long-code positioning signals, e.g., terrestrial network signals or other (non-satellite) non-terrestrial network signals.

Positioning signals may comprise DSSS (Direct Sequence Spread Spectrum) signals and/or may carry low data-rate messages, e.g., to provide almanac and ephemeris information in SPS signals.

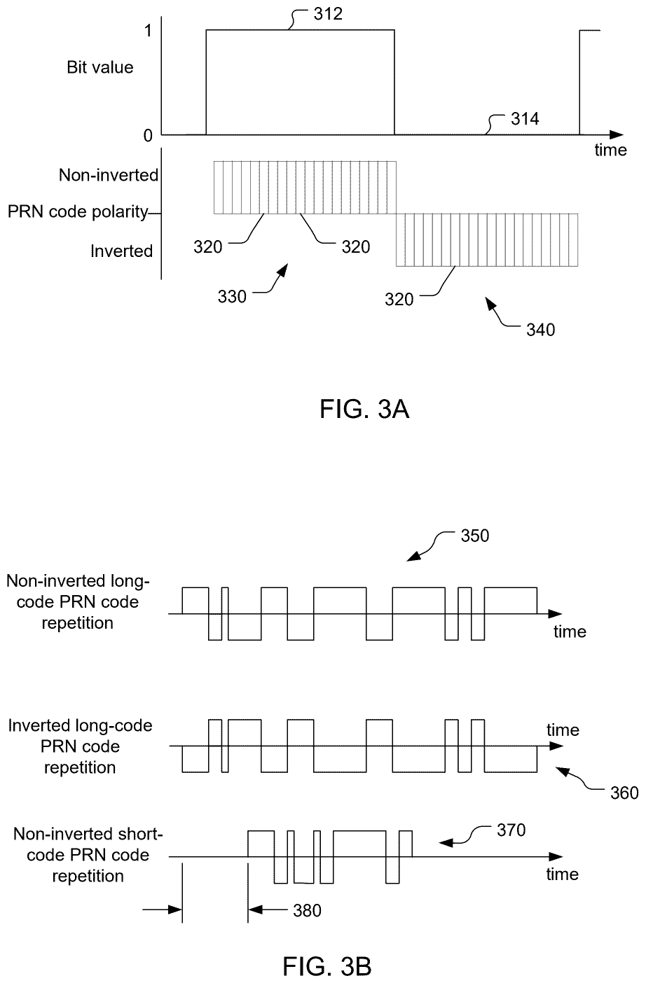

Referring also to FIG. 3A and FIG. 3B, within each duration of a data bit, e.g., bits 312, 314, modulating a positioning signal, there may be multiple repetitions 320 of a PRN code (Pseudorandom Noise code) unique to a respective source of the positioning signal, e.g., to one of the SVs 190-193. For example, in GPS L1, there are 20 repetitions of a 1 ms PRN sequence for each bit of a data message conveyed by a positioning signal. The repetitions 320 during a time corresponding to a bit with a bit value of “1” (here, the bit 312) may be a non-inverted set 330 of the repetitions 320 and the repetitions 320 during a time corresponding to a bit with a value of “0” (here, the bit 314) may be an inverted set 340 of the repetitions 320. As shown in FIG. 3B, an example simplified non-inverted PRN code repetition 350 and an example simplified inverted PRN code repetition 360 have opposite polarities and thus will destructively add if combined.

Also as shown in FIG. 3B, a short-code signal 370 comprises a code sequence that has fewer chips than the long-code sequence of the repetition 350. The short-code signal 370 may have a fixed time relationship relative to a respective long-code signal, e.g., a fixed time offset 380 relative to the repetition 350.

Multiple satellite bands are allocated to satellite usage. These bands include the L-band, used for GNSS satellite communications, the C-band, used for communications satellites such as television broadcast satellites, the X-band, used by the military and for RADAR applications, and the Ku-band (primarily downlink communication) and the Ka-band (primarily uplink communications), the Ku and Ka bands used for communications satellites. The L-band is defined by IEEE as the frequency range from 1 to 2 GHz. The L-Band is utilized by the GNSS satellite constellations such as GPS, Galileo, GLONASS, and BeiDou, and is broken into various bands, including L1, L2, L5, and L6. For location purposes, the L1 band has historically been used by commercial GNSS receivers. However, measuring GNSS signals across more than one band may provide for improved accuracy and availability.

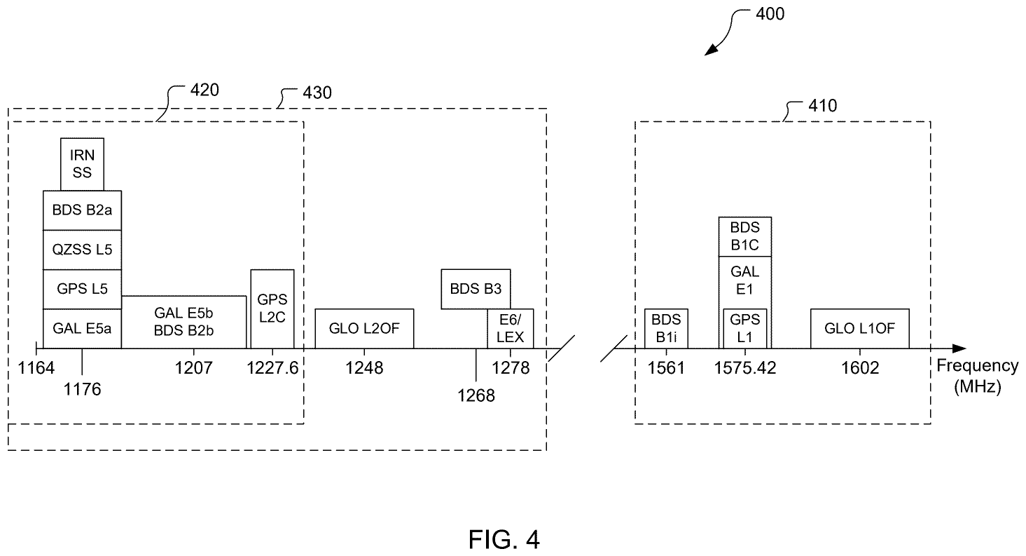

Referring also to FIG. 4 (which, like other figures, is not shown to scale), a frequency band plot 400 shows that GNSS constellations operate on several frequencies in the L-Band. The L1 frequency band typically covers frequencies from 1559 MHz to 1606 MHz and includes L1 signals from GPS, Galileo, Beidou, GLONASS, and QZSS GNSS constellations. These same constellations also transmit concurrently using another frequency in the L2 frequency band and/or the L5 frequency band. The L2 and L5 signals may complement the L1 signals, which have been used for many years. For example, the L5 signals have wider signal bandwidth than the L1 signals, which helps improve positioning performance in multi-path environments. Also, using the L5 signals in addition to the L1 signals provides frequency diversity. The L2 and L5 signals are far enough away in frequency from the L1 signals that different processing paths are typically used to measure the L2 and L5 signals versus the L1 signals. The L1 band extends over a frequency range 410 that is similar to a frequency range 420 over which the L2 and L5 bands extend. Consequently, similar receive chains may be used to process signals in the L1 band and signals in a combination of the L2 and L5 bands. A frequency range 430 that includes the L2, L5, and L6 bands may use a different receive chain (e.g., with a higher sampling rate due to the larger bandwidth of the frequency range 430 compared to the frequency ranges 410, 420) to process the signals. While the discussion herein focuses on the L1, L2, L5, and L6 bands, the discussion (including the claims) are not limited to these bands, nor is the discussion limited to the use of satellite signals in two or three bands.

The Galileo E5 band includes an E5a band and an E5b band. The E5a band is centered at 1176.45 MHz and the E5b band is centered at 1207.14 MHZ. An E5 quasi-pilot (QP) signal has been introduced that will occupy a narrow portion of the E5 band, have a short code sequence, and provide a simpler signal structure using less calculation to decode, and thus enable faster acquisition and position fixes. The E5 QP signal will not have a secondary code sequence (another code sequence modulating the short-code sequence), and thus the E5 QP signal may be coherently integrated across multiple short-code periods without having to know the secondary code sequence and without having to first synchronize to a secondary code sequence). The E5 QP signal, or other short-code PRN signal, may be used for one or more purposes, as discussed herein, other than fast acquisition of a related long-code PRN signal.

Significant correlation resources are used for detection of signals with long-code PRN codes, especially in situations where code-phase uncertainty is high. The correlation resources used may be particularly high for L5-band SPS signals that use PRN codes that are generally 10 times longer than PRN codes for L1-band SPS signals.

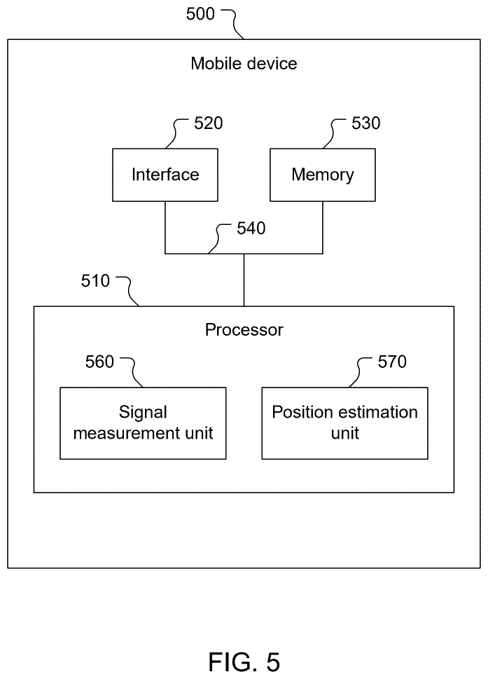

Referring to FIG. 5, with further reference to FIGS. 1-4, a mobile device 500 includes a processor 510, an interface 520, and a memory 530 communicatively coupled to each other by a bus 540. Even if referred to in the singular, the processor 510 may include one or more processors, the interface 520 may include one or more interfaces (e.g., transceivers including one or more transmitters and one or more receivers), and/or the memory 530 may include one or more memories. The mobile device 500 may include some or all of the components shown in FIG. 5, and may include one or more other components such as any of those shown in FIG. 2 such that the UE 200 may be an example of the mobile device 500. The processor 510 may include one or more components of the processor 210. The interface 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the interface 520 may include the wired transmitter 252 and/or the wired receiver 254. The interface 520 may include the SPS receiver 217 and the antennas 262, 263 to receive and process satellite signals of different frequencies (e.g., from different frequency bands). The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the mobile device 500 performing a function as shorthand for one or more appropriate components (e.g., the processor 510 and the memory 530) of the mobile device 500 performing the function. The processor 510 (possibly in conjunction with the memory 530 and, as appropriate, the interface 520) may include a signal measurement unit 560 and a position estimation unit 570. The signal measurement unit 560 may be configured to perform one or more functions for measuring long-code and/or short-code (positioning) signals, e.g., controlling receive chains of the mobile device 500 for measuring one or more positioning signals, with the mobile device 500 being configured to perform the function(s). Receive chains may be referred to as RF paths (radio frequency paths). The position estimation unit 570 may be configured to determine one or more position estimates for the mobile device 500, e.g., using measurement(s) of one or more SPS positioning signals, measurement(s) of one or more terrestrial-based positioning signals, and/or measurement(s) of one or more NTN positioning signals (other than SPS positioning signals), with the mobile device 500 being configured to perform the function(s).

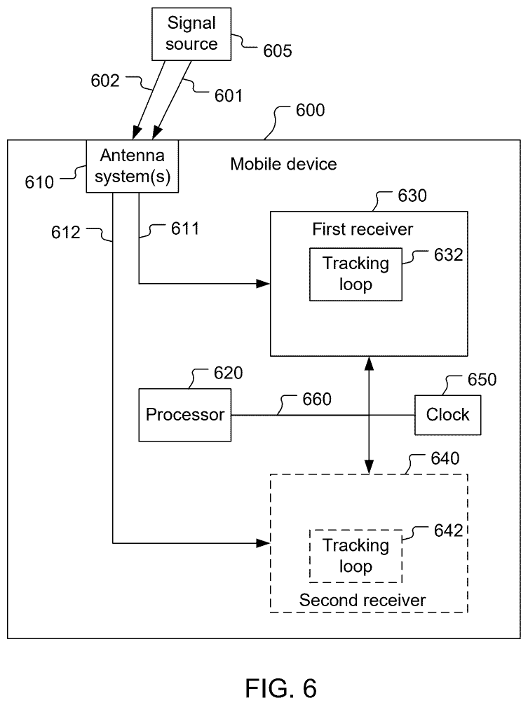

Referring to FIG. 6, with further reference to FIG. 5, a mobile device 600, which may be an example of the mobile device 500, includes one or more antenna systems 610, a processor 620, a first receiver 630, may include a second receiver 640, and includes a clock 650. The processor 620 may be an example of the processor 510 and may include memory (e.g., the memory 530). The processor 620, the receivers 630, 640, and the clock 650 are communicatively coupled to each other by a bus 660. The antenna system(s) 610 is (are) communicatively coupled to the receivers 630, 640, and may be configured to receive and convert a first wireless signal 601 into a first received signal 611 and to receive and convert a second wireless signal 602 into a second received signal 612. The signals 601, 602 may be positioning signals (e.g., PRS or SPS signals) and may be in the same frequency range. The signals 601, 602 are from a signal source 605 that may be an SV, another NTN signal source, or a terrestrial signal source. For example, the positioning signal 601 may be a short-code PRN signal in a first frequency range and the positioning signal 602 may be a long-code PRN signal in a second frequency range, that may be the same as, overlapping with, or separate from the first frequency range. The mobile device 600 is configured to process the signal 601 for one or more purposes other than for expediting acquisition of the signal 602.

Each of the receivers 630, 640 may include a respective portion of the antenna system(s) 610. For example, the receiver 630 may be configured to process signals in a first frequency band and may include a first antenna system, including a first antenna, of the antenna system(s) 610 that is configured to transduce signals in the first frequency band. Similarly, the receiver 640 may be configured to process signals in a second frequency band and may include a second antenna system, including a second antenna, of the antenna system(s) 610 that is configured to transduce signals in the second frequency band. The first and second frequency bands may be different, with the antennas of the antenna system(s) 610 corresponding to the receivers 630, 640 being different. The receiver 630, in conjunction with the processor 620, is configured to receive, acquire, and measure short-code PRN signals and the receiver 640 (if present), in conjunction with the processor 620, is configured to receive, acquire, and measure short-code PRN signals. The receiver 640 is optional and may be omitted from the mobile device 600 (e.g., if the mobile device 600 will use detection of short-code signals, e.g., for environment detection and/or time maintenance, without detecting/acquiring/measuring long-code PRN signals).

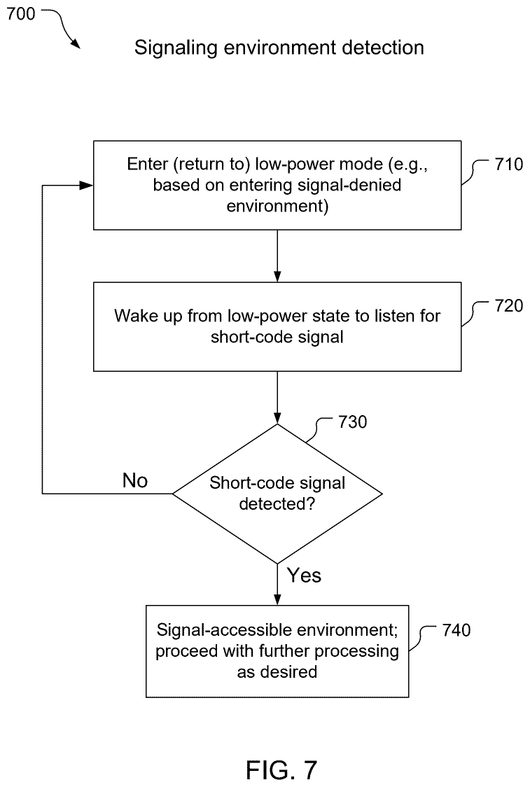

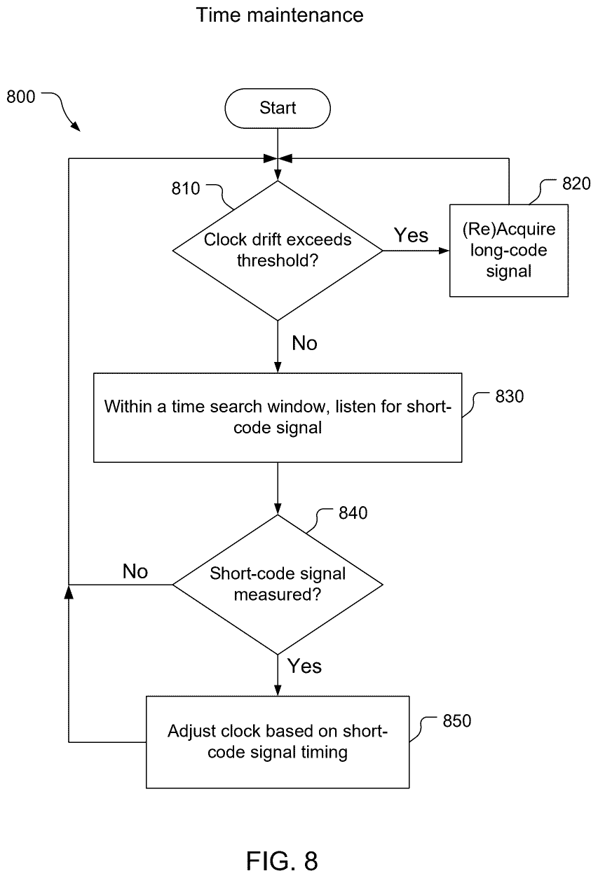

Referring to FIG. 7, with further reference to FIG. 5 and FIG. 6, a method 700 for signaling environment detection includes the stages shown. The method 700 is, however, an example and not limiting. The method 700 may be altered, e.g., by having one or more stages added, removed, rearranged, combined, performed concurrently, and/or having single stages split into multiple stages. The discussion of FIG. 7 (as with the discussions for FIGS. 8-11) focuses on the mobile device 600, but other apparatus may be used to implement the method 700 (or any of the methods discussed with respect to FIGS. 8-11).

At stage 710, the mobile device 600 enters (e.g., initially or returns to) a low-power mode. The mobile device 600 may enter the low-power mode based on the mobile device 600 entering a signal-denied environment (e.g., deep indoors) where one or more signals desired to be measured (e.g., one or more long-code PRN signals) cannot be acquired and measured. The mobile device 600 may enter the low-power mode by putting one or more portions of the mobile device 600 to sleep, without putting the entire mobile device 600 to sleep. For example, the receiver 630 and the receiver 640 (if present) may be put into low-power mode without other portions of the mobile device 600 being put into low-power mode.

At stage 720, the mobile device 600 wakes up from the low-power state to listen for a short-code PRN signal. It may be desirable to intermittently (e.g., periodically) wake up to check if a strong SPS signal is available (e.g., if the mobile device 600 has moved from deep indoors to outdoors). The mobile device 600 may, for example, wake up after being in low-power mode for 10 seconds, or 20 seconds, or 30 seconds, or possibly an increasing time such as an exponentially increasing time (e.g., 10 seconds for a first sleep time, then 20 seconds, then 40 seconds, etc. although there may be a maximum sleep time such as two (2) minutes). The mobile device 600 may use the receiver 630 to listen for one or more short-code PRN signals, e.g., the Galileo E5 QP signal. Listening for a short-code signal may be more efficient for the intermittent wake-ups, e.g., using less power and time, than listening for a long-code signal in order to determine whether the mobile device is in a signal-available environment. Listening for the E5 QP signal may be the most efficient way to detect signal availability, at least for an L5-only receiver. The mobile device 600 may listen at stage 720 for a limited amount of time, e.g., hundreds of (e.g., 300 or more) times of a length of the short-code signal for which the mobile device 600 is listening. For example, the mobile device 600 might listen for 20 ms or 80 ms.

At stage 730, the mobile device 600, e.g., the processor 620 (e.g., the signal measurement unit 560), may determine whether a short-code signal has been detected. The mobile device 600 determines whether a short-code signal has been detected (i.e., the mobile device 600 can tell that a signal is the short-code signal even if the mobile device 600 does not measure the short-code signal to determine information (e.g., time-of-arrival, power, etc.) from the short-code signal). If the mobile device 600 determines that the short-code signal has not been detected, or at least does not determine that the short-code signal has been detected, then the method returns to stage 710 and the mobile device 600 returns to the low-power mode. If the mobile device 600 determines that the short-code signal has been detected, then the method 700 proceeds to stage 740.

At stage 740, the mobile device determines that the mobile device 600 is in a signal-accessible environment. The mobile device 600 may proceed with further processing, e.g., measuring a long-code PRN signal corresponding to the short-code PRN signal, or using information about the detected short-code PRN signal (e.g., as discussed with respect to FIG. 8). By listening for the short-code PRN signal, the mobile device 600 can determine whether the mobile device 600 is in a signal-accessible environment (e.g., a positioning-signal-accessible environment) using less power than listening for a long-code PRN signal, thus providing low-power signaling environment detection.

Referring to FIG. 8, with further reference to FIG. 5 and FIG. 6, a method 800 for time maintenance includes the stages shown. The method 800 is, however, an example and not limiting. The method 800 may be altered, e.g., by having one or more stages added, removed, rearranged, combined, performed concurrently, and/or having single stages split into multiple stages. In the method 800, SPS positioning may not be needed, but maintenance of time uncertainty of the mobile device 600, or at least the receiver 640, below an acceptable threshold is desired (e.g., to guarantee an acceptable time to first fix (TTFF) when positioning is again desired).

At stage 810, the mobile device 600 determines whether a clock drift threshold has been exceeded. For example, the processor 620 may determine based on a timer and historical knowledge of the drift of the clock 650 as a function of time (and possibly one or more other parameters such as temperature) whether the clock drift since a most-recent time determination/correction was made has exceeded the duration of the short-code signal PRN sequence. If the mobile device 600 determines that the clock drift has exceeded the threshold, then the method 800 proceeds to stage 820 where a (re) acquisition procedure is performed to acquire a long-code signal to determine time information, and then the method 800 returns to stage 810. If the mobile device 600 determines at stage 810 that the clock drift has not exceeded the threshold, then the method 800 proceeds to stage 830.

At stage 830, within a search time window, the mobile device 600 listens for the short-code signal. For example, before clock drift since a most-recent time determination/correction was made exceeds a percentage (less than 100%) of the short-code PRN sequence (e.g., to provide a safety margin for time to detect and measure the short-code signal), the processor 620 may cause the receiver 630 to listen for the short-code signal. The processor 620 may determine when to have the receiver 630 listen for the short-code signal based on a timer and historical knowledge of the drift of the clock 650 as a function of time (and possibly one or more other parameters such as temperature).

At stage 840, the mobile device 600 may determine whether the short-code signal was measured. For example, the processor 620, e.g., the signal measurement unit 560, may determine whether the short-code signal was measured to determine timing information. The measured time of arrival of the short-code signals from one or more satellite vehicles may be used to determine a time correction for adjusting the time determined by the processor 620 from the clock 650. If the short-code signal was not measured, then the method 800 returns to stage 810. If the short-code signal was measured, then the method 800 proceeds to stage 850.

At stage 850, the mobile device 600 adjusts the time determined at the mobile device 600. For example, the processor 620 adjusts a correction to the clock 650 for determining the time. The method 800 may then return to stage 810. By using the short-code signal to determine time updates, the power efficiency of maintaining accurate time is improved compared to measuring long-code signals for time maintenance. Also, if the short-code signal is data-less, such as with the E5 QP signal, and thus not modulated by a data sequence, long integration may be performed, resulting in high sensitivity of signal acquisition/measurement, e.g., higher sensitivity than using a long-code signal to determine timing information.

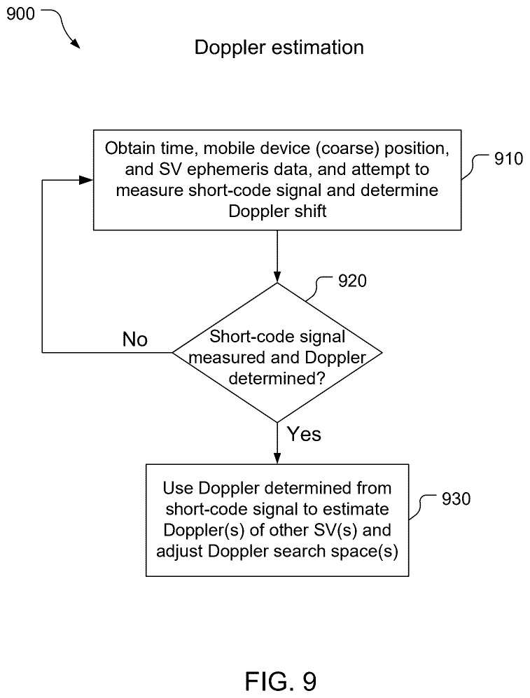

Referring to FIG. 9, with further reference to FIG. 5 and FIG. 6, a method 900 for estimating and using Doppler shift to search for long-code signals includes the stages shown. The method 900 is, however, an example and not limiting. The method 900 may be altered, e.g., by having one or more stages added, removed, rearranged, combined, performed concurrently, and/or having single stages split into multiple stages. The method 900 may be particularly useful in devices with L5-band-only SPS receivers.

At stage 910, the mobile device 600 obtains time, mobile device position, and signal source position data (e.g., SV ephemeris data), listens for a short-code signal, and attempts to measure the Doppler shift of the short-code signal. The device position may be a coarse device position, e.g., determined from E-CID and/or using another technique (e.g., image capture, landmark identification, and ranging to the landmark). If a short-code signal is received (with sufficient quality, e.g., power level (e.g., RSSI) and/or SNR (Signal-to-Noise Ratio), etc.), then the short-code signal can be measured to determine a Doppler shift of the short-code signal. The Doppler shift may be determined by frequency shifting (using multiple hypotheses) the incoming signal and/or the reference signal with which the incoming signal is correlated, and determining the frequency shift yielding the highest correlation.

At stage 920, the mobile device 600 determines whether the short-code signal was received and measured and the Doppler shift determined. If the mobile device 600 determines that the Doppler shift of a short-code signal was not determined, then the method 900 returns to stage 910. If the mobile device 600 determines that the Doppler shift of a short-code signal was determined, then the method 900 proceeds to stage 930.

At stage 930, the mobile device 600 uses the Doppler shift determined for the short-code signal (and possibly one or more Doppler shifts) and the signal source position data to estimate the Doppler shift for each of one or more other signals. The mobile device 600, e.g., the signal measurement unit 560, may estimate the Doppler shift for another signal using signal source differencing (e.g., SV differencing), and use the estimated Doppler shift to narrow a frequency search space for the other signal. By measuring a short-code signal instead of a long-code signal, a reference Doppler shift may be determined more quickly and more efficiently (e.g., using less power). The mobile device 600 may compare the Doppler shifts of the signals 601, 602, and identify an error if a difference between the Doppler shifts exceeds a threshold, e.g., 25 Hz. If the difference in Doppler shifts exceeds the threshold, then the mobile device 600 may not use the determined short-code signal Doppler shift to estimate the Doppler shift of other signal sources, e.g., other SVs.

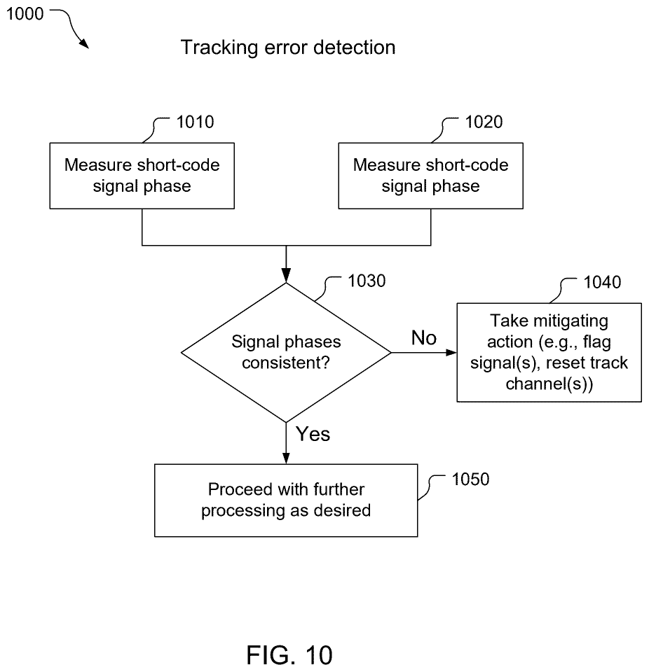

Referring to FIG. 10, with further reference to FIG. 5 and FIG. 6, a method 1000 for detecting errors in signals, e.g., positioning signals, includes the stages shown. For example, the method 1000 may be used to use the E5 QP signal as an error detection mechanism. The method 1000 is, however, an example and not limiting. The method 1000 may be altered, e.g., by having one or more stages added, removed, rearranged, combined, performed concurrently, and/or having single stages split into multiple stages.

At stage 1010, the mobile device 600, e.g., using the first receiver 630, measures a short-code signal phase. For example, the first receiver 630 (including an appropriate antenna system of the antenna system(s) 610, receives a short-code signal (e.g., the E5 QP signal) and measures a phase, e.g., a code phase, of the short-code signal.

At stage 1010, the mobile device 600, e.g., using the first receiver 630, measures a short-code signal phase. For example, the first receiver 630 (including an appropriate antenna system of the antenna system(s) 610, receives the signal 601, which in this example is a short-code signal (e.g., the E5 QP signal), and measures a phase, e.g., a code phase, of the short-code signal.

At stage 1020, the mobile device 600, e.g., using the second receiver 640 (with the mobile device 600 including the second receiver 640), measures a long-code signal phase. For example, the second receiver 640 (including an appropriate antenna system of the antenna system(s) 610, receives the signal 602, which in this example is a long-code signal (e.g., the E5a or E5b signal), and measures a phase, e.g., a code phase, of the long-code signal. The signals 601, 602 are received from the same signal source, here the signal source 605, e.g., the same SV.

At stage 1030, the mobile device 600 compares the phases determined at stages 1010, 1020 and determines whether the phases of the short-code and long-code signals are consistent. For example, the mobile device 600 may determine whether the code phases of the signals 601, 602 are at a constant offset+/−an offset error threshold (e.g., 100m). If the phases of the signals 601, 602 are consistent, then the method 1000 proceeds to stage 1050 where the mobile device 600 proceeds with any desired signal processing (e.g., range estimation and/or position estimation, etc.). If the phases of the signals 601, 602 are not consistent (e.g., due to signal jamming, signal spoofing, etc.), then there is an error in at least one of the signals 601, 602 and/or an error in processing (e.g., measuring) at least one of the signals 601, 602 and the method 1000 proceeds to stage 1040.

At stage 1040, the mobile device 600 implements one or more mitigation actions to try to reduce the impact of an error in a received signal and/or an error in processing of a received signal. For example, the mobile device 600, e.g., the processor 620, may change (e.g., reset to default) one or more parameters of a track channel, e.g., one or more parameters of a tracking loop 632, of the first receiver 630 and/or one or more parameters of a track channel, e.g., one or more parameters of a tracking loop 642, of the second receiver 640. A track channel may be reset in order to perform a reacquisition of a respective signal. One or more track channel parameters may be set based on some knowledge, e.g., of receiver position, so that one or more parameters (e.g., steering of a channel (direction of signal) may not be set to a respective default value. This may help speed up the reacquisition process, e.g., if the track channel parameter(s) is (are) near the value(s) that the parameter(s) should be to acquire the respective signal. Based on the inconsistency being detected, one or more signal characteristics may be analyzed to try to determine if any of the measured signals is good. For example, received signal strength may be used to determine whether a received signal is good, e.g., with a received strength above a threshold indicating a spoofed signal, or with a stronger of the received signals being determined to be good as long as that signal is not otherwise determined to be bad (e.g., spoofed). Also or alternatively, the processor 620 may flag one or more measurements of the signals 601, 602 as being suspicious or unusable such that the processor 620 (and/or another (e.g., higher-level) entity) determine what to do with the flagged measurement(s) (e.g., whether to use the measurement(s), whether de-weight the measurement(s), etc.). Also or alternatively, one or more other mitigating actions may be taken to try to decrease (e.g., minimize) an impact of an erroneous signal (e.g., erroneous signal reception and/or processing).

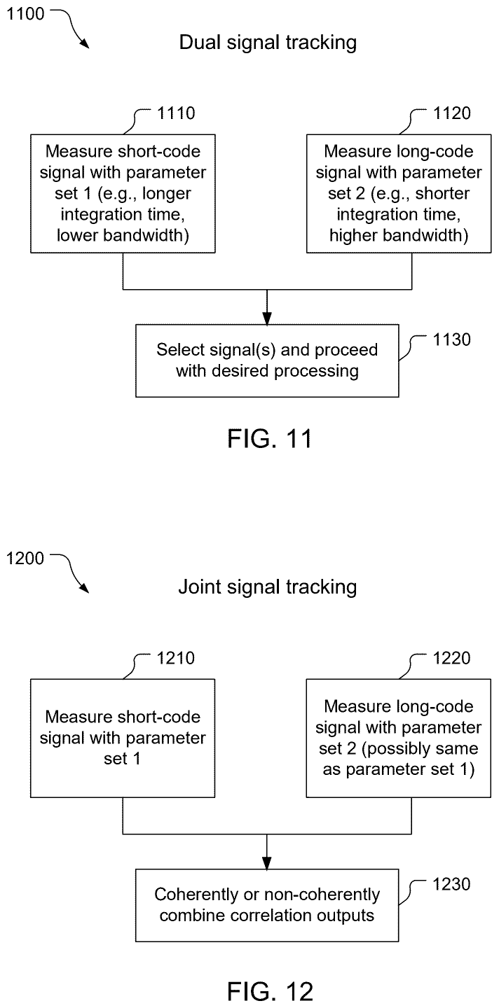

Referring to FIG. 11, with further reference to FIG. 5 and FIG. 6, a method 1100 for dual signal tracking includes the stages shown. The method 1100 is, however, an example and not limiting. The method 1100 may be altered, e.g., by having one or more stages added, removed, rearranged, combined, performed concurrently, and/or having single stages split into multiple stages. In the method 1100, different signals may be measured/tracked with different values of one or more measurement/tracking parameters, which may provide different beneficial qualities for the signals which may allow for measurement/tracking in different conditions.

At stage 1110, the mobile device 600 measures a short-code signal with a first parameter set of measurement/tracking parameters and corresponding parameter values. For example, the measurement at stage 1110 may have a relatively long coherent integration time (PDI (Pre-Detection Interval)). A long coherent integration time may be used if the short-code signal is not data modulated (such as with the E5 QP signal), or if the short-code signal is data modulated and the data pattern is known. The relatively long integration time provides for good sensitivity, allowing for signal measurement in weak signal conditions. Also or alternatively, the measurement at stage 1110 may have a relatively low tracking loop bandwidth (e.g., phase-locked loop bandwidth or frequency-locked loop bandwidth).

At stage 1120, the mobile device 600 measures a long-code signal (from the same signal source, e.g., the same SV, as the short-code signal measured at stage 1110) with a second parameter set of measurement/tracking parameters and corresponding parameter values. The first and second parameter sets may have different sets of parameters and/or one or more different parameter values. For example, the measurement at stage 1120 may have a relatively short coherent integration time (e.g., shorter than the integration time of stage 1110) due to the long-code signal (e.g., an E5a or E5b signal) being data modulated with the data pattern being unknown. Also or alternatively, the measurement at stage 1120 may have a relatively high tracking loop bandwidth (e.g., phase-locked loop bandwidth or frequency-locked loop bandwidth). The relatively high bandwidth (e.g., higher than the bandwidth of stage 1110) may provide acceptable signal measurement in the presence of greater signal dynamics (i.e., changing code phase and/or changing carrier phase).

At stage 1130, the mobile device 600 selects one or more of the signal measurements from stages 1110, 1120 for use in desired processing (e.g., range determination, position estimation, etc.). For example, in good signal conditions (e.g., strong signals, low signal dynamics), the mobile device 600 (e.g., the position estimation unit 570) may use measurements of signals from both of the stages 1110, 1120 to determine a position estimate for the mobile device 600. As another example, in weak signal conditions, the mobile device 600 may use only the measurement(s) from stage 1110 for further processing. As another example, in the presence of high signal dynamics, the mobile device 600 may use only the measurement(s) from stage 1120 for further processing. The selective processing at stage 1130 allows different signal conditions to be accommodated while achieving desired results, e.g., accurate position estimation. The different measurements at stages 1110, 1120 in combination with the selective processing at stage 1130 allows for improved measurement/processing quality, reliability, and/or availability. For example, short-code signal tracking may be used to augment long-code signal tracking under conditions that compromise long-code signal tracking.

Referring to FIG. 12, with further reference to FIG. 5 and FIG. 6, a method 1200 for dual signal tracking includes the stages shown. The method 1200 is, however, an example and not limiting. The method 1200 may be altered, e.g., by having one or more stages added, removed, rearranged, combined, performed concurrently, and/or having single stages split into multiple stages.

At stage 1210, the mobile device 600 measures a short-code signal with a first parameter set of measurement/tracking parameters and corresponding parameter values. The mobile device 600 determines a first correlation output (e.g., with real and imaginary values, or magnitude and phase values).

At stage 1220, the mobile device 600 measures a long-code signal (from the same signal source, e.g., the same SV, as the short-code signal measured at stage 1110) with a second parameter set of measurement/tracking parameters and corresponding parameter values. The first and second parameter sets may be the same or may be different, having different sets of parameters and/or one or more different parameter values. The mobile device 600 determines a second correlation output (e.g., with real and imaginary values, or magnitude and phase values).

At stage 1230, the mobile device 600 combines the first and second correlation outputs. For example, the mobile device 600 may coherently combine (e.g., add) the first and second correlation outputs if the tracking parameter sets for measuring the short-code and long-code signals were the same. As another example, the mobile device 600 may non-coherently combine (e.g., add) the first and second correlation outputs even if the tracking parameter sets for measuring the short-code and long-code signals were not the same. For example, the mobile device 600 may combine magnitudes (e.g., energies corresponding to squared magnitudes) of the first and second correlation outputs. Combining the first and second correlation outputs may provide for improved SNR for signal detection and measurement.

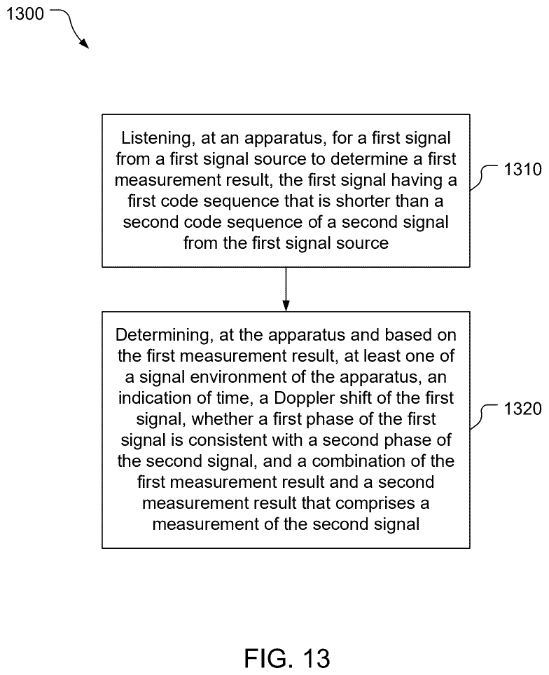

Referring to FIG. 13, with further reference to FIGS. 1-12, a method 1300 of using at least an attempt to measure a short-code-phase signal includes the stages shown. The method 1300 is, however, an example and not limiting. The method 1300 may be altered, e.g., by having one or more stages added, removed, rearranged, combined, performed concurrently, and/or having single stages split into multiple stages. Examples are provided below for using the E5 QP signal, but the disclosure is not limited to this short-code signal, and is not limited to receiving (or detecting or measuring) satellite signals (also called SV signals).

At stage 1310, the method 1300 includes listening, at an apparatus, for a first signal from a first signal source to determine a first measurement result, the first signal having a first code sequence that is shorter than a second code sequence of a second signal from the first signal source. For example, the mobile device 600 (e.g., the first receiver 630) may listen for the signal 601, e.g., at stage 720, with the signal 601 having a shorter code sequence (fewer chips) than the code sequence of the signal 602. The receiver 610 (e.g., including an antenna system (e.g., an antenna and possibly a front-end circuit)) may comprise means for listening for the first signal.

At stage 1320, the method 1300 includes determining, at the apparatus and based on the first measurement result, at least one of a signal environment of the apparatus, an indication of time, a Doppler shift of the first signal, whether a first phase of the first signal is consistent with a second phase of the second signal, and a combination of the first measurement result and a second measurement result that comprises a measurement of the second signal. For example, using a lack of a measurement of the signal 601 the processor 620 may determine an environment of the mobile device 600, or using a measurement of the signal 601 the processor 620 may determine time, or a Doppler shift of the signal 601, or phase consistency with a measurement of the signal 602, or a combination of measurements of the signals 601, 602. The processor 620 may comprise the means for determining.

Implementations of the method 1300 may include one or more of the following features. In an example implementation, the method 1300 further includes: entering, by the apparatus, a low-power mode; waking up from the low-power mode to listen for the first signal; and re-entering the low-power mode based on the first measurement result being a failure to measure the first signal within a threshold duration. For example, at stage 710 the mobile device 600 may enter a low-power mode (e.g., for a portion, that is less than all, of the mobile device 600 such as the receiver 630), and at stage 720 may wake up from the low-power mode to listen for a short-code signal, e.g., the signal 601. The mobile device 600 may return to stage 710 if the mobile device 600 fails to measure the signal 601 (e.g., because the signal 601 is not present, or is too weak to be measured, etc.). The processor 620 in combination with the receiver 630 may comprise means for entering the low-power mode, means for waking up from the low-power mode, and means for re-entering the low-power mode. In another example implementation, the method 1300 includes measuring the first signal at a plurality of times, wherein the determining comprises determining the indication of time for each of the plurality of times that the first signal is measured. For example, the processor 620 measures the signal 601 at multiple times and determines, for each measurement, an indication of time, e.g., that the processor 620 can use to adjust a time maintained by the processor 620 using the clock 650. For example, the processor 620 may measure the signal 601 and adjust the time in accordance with the method 800. The processor 620 may comprise means for measuring the first signal at a plurality of times. In another example implementation, the method 1300 includes measuring the first signal, wherein the determining comprises determining the Doppler shift of the first signal, and the method further comprises estimating a Doppler shift for a third signal of a second signal source that is separate from the first signal source. For example, in accordance with the method 900, the processor 620 may determine a Doppler shift of the signal 601 and estimates the Doppler shift for one or more signals transmitted by one or more other signal sources, i.e., other than the signal source of the signal 601, e.g., other SVs than an SV that transmitted the signal 601. The processor 620 may comprise means for determining the Doppler shift of the first signal 601 and estimating the Doppler shift of a third signal from a second signal source. In another example implementation, the method 1300 includes measuring the first signal and measuring the second signal, where the determining comprises determining whether the first phase of the first signal is consistent with the second phase of the second signal, and the method 1300 further comprises performing, at the apparatus, a mitigation action based on the first phase of the first signal being inconsistent with the second phase of the second signal. For example, in accordance with the method 1000, the processor may determine a disparity between phases of signals from the same signal source and take appropriate mitigating action(s) based on the disparity. The processor 620 may comprise means for measuring the first and second signals, determining the phases of the signals, and performing a mitigation action.

Also or alternatively, implementations of the method 1300 may include one or more of the following features. In an example implementation, the method 1300 includes measuring the first signal, wherein the method further comprises measuring the second signal differently than the measuring of the first signal. For example, in accordance with the method 1100 the processor 620, in combination with the first and second receivers 630, 640, may measure the signals 601, 602 with different measurement parameters/parameter values. The processor 620 in combination with the receivers 630, 640 may comprise means for measuring the second signal differently than the first signal. In a further example implementation, the method 1300 includes measuring the first signal comprises integrating for a first coherent integration time and measuring the second signal comprises integrating for a second coherent integration time that is shorter than the first coherent integration time. For example, the processor 620 may coherently integrate the first signal 601 longer than the second signal 602, e.g., up to a bit length for the signal 602 due to data modulation, and longer for the signal 601 based on a lack of data modulation on the signal 601 (e.g., an E5 QP signal). The processor 620 may comprise means for integrating the first signal and means for integrating the second signal.

Also or alternatively, implementations of the method 1300 may include one or more of the following features. In an example implementation, the method 1300 includes measuring the first signal and measuring the second signal, wherein the determining comprises coherently combining a first correlation output of the first measurement result with a second correlation output of the second measurement result. For example, in accordance with the method 1200, the processor 620 in combination with the receivers 630, 640 may measure the signals 601, 602 and coherently combine correlation outputs of the measurements. The processor 620 in combination with the receivers 630, 640 may comprise means for measuring the first and second signals, and the processor 620 may comprise means for coherently combining the correlation outputs. In another example implementation, the method 1300 includes measuring the first signal and measuring the second signal, wherein the determining comprises non-coherently combining a first correlation output of the first measurement result with a second correlation output of the second measurement result. For example, in accordance with the method 1200, the processor 620 in combination with the receivers 630, 640 may measure the signals 601, 602 and non-coherently combine correlation outputs of the measurements. The processor 620 in combination with the receivers 630, 640 may comprise means for measuring the first and second signals, and the processor 620 may comprise means for non-coherently combining the correlation outputs.

### Implementation Examples

Implementation examples are provided in the following numbered clauses.

Clause 1. A method of using at least an attempt to measure a short-code-phase signal, the method comprising:
listening, at an apparatus, for a first signal from a first signal source to determine a first measurement result, the first signal having a first code sequence that is shorter than a second code sequence of a second signal from the first signal source; and
determining, at the apparatus and based on the first measurement result, at least one of a signal environment of the apparatus, an indication of time, a Doppler shift of the first signal, whether a first phase of the first signal is consistent with a second phase of the second signal, and a combination of the first measurement result and a second measurement result that comprises a measurement of the second signal.

Clause 2. The method of clause 1, further comprising:
entering, by the apparatus, a low-power mode;
waking up from the low-power mode to listen for the first signal; and
re-entering the low-power mode based on the first measurement result being a failure to measure the first signal within a threshold duration.

Clause 3. The method of clause 1, further comprising measuring the first signal at a plurality of times, wherein the determining comprises determining the indication of time for each of the plurality of times that the first signal is measured.

Clause 4. The method of clause 1, further comprising measuring the first signal, wherein the determining comprises determining the Doppler shift of the first signal, and the method further comprises estimating a Doppler shift for a third signal of a second signal source that is separate from the first signal source.

Clause 5. The method of clause 1, further comprising measuring the first signal and measuring the second signal, wherein the determining comprises determining whether the first phase of the first signal is consistent with the second phase of the second signal, and the method further comprises performing, at the apparatus, a mitigation action based on the first phase of the first signal being inconsistent with the second phase of the second signal.

Clause 6. The method of clause 1, further comprising measuring the first signal, wherein the method further comprises measuring the second signal differently than the measuring of the first signal.

Clause 7. The method of clause 6, wherein measuring the first signal comprises integrating for a first coherent integration time and measuring the second signal comprises integrating for a second coherent integration time that is shorter than the first coherent integration time.

Clause 8. The method of clause 1, further comprising measuring the first signal and measuring the second signal, wherein the determining comprises coherently combining a first correlation output of the first measurement result with a second correlation output of the second measurement result.

Clause 9. The method of clause 1, further comprising measuring the first signal and measuring the second signal, wherein the determining comprises non-coherently combining a first correlation output of the first measurement result with a second correlation output of the second measurement result.

Clause 10. An apparatus comprising:
at least one receiver configured to listen for a first signal from a first signal source, the first signal having a first code sequence that is shorter than a second code sequence of a second signal from the first signal source; and
at least one processor communicatively coupled to the at least one receiver and configured to:
   determine a first measurement result based on the at least one receiver listening for the first signal; and
   determine, based on the first measurement result, at least one of presence/absence of the first signal, an indication of time, a Doppler shift of the first signal, whether a first phase of the first signal is consistent with a second phase of the second signal, and a combination of the first measurement result and a second measurement result that comprises a measurement of the second signal.

Clause 11. The apparatus of clause 10, wherein the at least one processor is further configured to:
cause the apparatus to enter a low-power mode;
intermittently cause the apparatus to wake up from the low-power mode to listen for the first signal; and
cause the apparatus to re-enter the low-power mode based on the first measurement result being a failure to measure the first signal within a threshold duration.

Clause 12. The apparatus of clause 10, wherein the at least one processor is configured to measure the first signal at a plurality of times, and to determine the indication of time for each of the plurality of times that the first signal is measured.

Clause 13. The apparatus of clause 10, wherein the at least one processor is configured to measure the first signal, determine the Doppler shift of the first signal, and estimate a Doppler shift for a third signal of a second signal source that is separate from the first signal source.

Clause 14. The apparatus of clause 10, wherein the at least one receiver is configured to listen for the second signal from the first, and wherein the at least one processor is configured to:
measure the first signal;
measure the second signal;
determine whether the first phase of the first signal is consistent with the second phase of the second signal; and
perform a mitigation action based on the first phase of the first signal being inconsistent with the second phase of the second signal.

Clause 15. The apparatus of clause 10, wherein the at least one receiver is configured to listen for the second signal from the first, and wherein the at least one processor is configured to:
measure the first signal; and
measure the second signal differently than the first signal.

Clause 16. The apparatus of clause 15, wherein the at least one processor is configured to integrate the first signal for a first coherent integration time and to integrate the second signal for a second coherent integration time that is shorter than the first coherent integration time.

Clause 17. The apparatus of clause 10, wherein the at least one receiver is configured to listen for the second signal from the first, and wherein the at least one processor is configured to:
measure the first signal;
measure the second signal; and
coherently combine a first correlation output of the first measurement result with a second correlation output of the second measurement result.

Clause 18. The apparatus of clause 10, wherein the at least one receiver is configured to listen for the second signal from the first, and wherein the at least one processor is configured to:
measure the first signal;
measure the second signal; and
non-coherently combine a first correlation output of the first measurement result with a second correlation output of the second measurement result.

Clause 19. An apparatus comprising:
means for listening for a first signal from a first signal source to determine a first measurement result, the first signal having a first code sequence that is shorter than a second code sequence of a second signal from the first signal source; and
means for determining, based on the first measurement result, at least one of a signal environment of the apparatus, an indication of time, a Doppler shift of the first signal, whether a first phase of the first signal is consistent with a second phase of the second signal, and a combination of the first measurement result and a second measurement result that comprises a measurement of the second signal.

Clause 20. The apparatus of clause 19, further comprising:
means for entering, by the apparatus, a low-power mode;
means for waking up from the low-power mode to listen for the first signal; and
means for re-entering the low-power mode based on the first measurement result being a failure to measure the first signal within a threshold duration.

Clause 21. The apparatus of clause 19, further comprising means for measuring the first signal at a plurality of times, wherein the means for determining comprise means for determining the indication of time for each of the plurality of times that the first signal is measured.

Clause 22. The apparatus of clause 19, further comprising means for measuring the first signal, wherein the means for determining comprise means for determining the Doppler shift of the first signal, and the apparatus further comprises means for estimating a Doppler shift for a third signal of a second signal source that is separate from the first signal source.

Clause 23. The apparatus of clause 19, further comprising means for measuring the first signal and measuring the second signal, wherein the means for determining comprise means for determining whether the first phase of the first signal is consistent with the second phase of the second signal, and the apparatus further comprises means for performing a mitigation action based on the first phase of the first signal being inconsistent with the second phase of the second signal.

Clause 24. The apparatus of clause 19, further comprising means for measuring the first signal, wherein the apparatus further comprises means for measuring the second signal differently than the measuring of the first signal.

Clause 25. The apparatus of clause 24, wherein the means for measuring the first signal comprise means for integrating for a first coherent integration time and the means for measuring the second signal comprise means for integrating for a second coherent integration time that is shorter than the first coherent integration time.

Clause 26. The apparatus of clause 19, further comprising means for measuring the first signal and means for measuring the second signal, wherein the means for determining comprise means for coherently combining a first correlation output of the first measurement result with a second correlation output of the second measurement result.

Clause 27. The apparatus of clause 19, further comprising means for measuring the first signal and means for measuring the second signal, wherein the means for determining comprise means for non-coherently combining a first correlation output of the first measurement result with a second correlation output of the second measurement result.

Clause 28. A non-transitory, processor-readable storage medium comprising processor-readable instructions to cause at least one processor of an apparatus, in order to use at least an attempt to measure a short-code-phase signal, to:
listen for a first signal from a first signal source to determine a first measurement result, the first signal having a first code sequence that is shorter than a second code sequence of a second signal from the first signal source; and
determine, based on the first measurement result, at least one of a signal environment of the apparatus, an indication of time, a Doppler shift of the first signal, whether a first phase of the first signal is consistent with a second phase of the second signal, and a combination of the first measurement result and a second measurement result that comprises a measurement of the second signal.

Clause 29. The non-transitory, processor-readable storage medium of clause 28, further comprising processor-readable instructions to cause the at least one processor to:
cause the apparatus to enter a low-power mode;
cause the apparatus to wake up from the low-power mode to listen for the first signal; and
cause the apparatus to re-enter the low-power mode based on the first measurement result being a failure to measure the first signal within a threshold duration.

Clause 30. The non-transitory, processor-readable storage medium of clause 28, further comprising processor-readable instructions to cause the at least one processor to measure the first signal at a plurality of times, wherein the processor-readable instructions to cause the at least one processor to determine comprise processor-readable instructions to cause the at least one processor to determine the indication of time for each of the plurality of times that the first signal is measured.

Clause 31. The non-transitory, processor-readable storage medium of clause 28, further comprising processor-readable instructions to cause the at least one processor to measure the first signal, wherein the processor-readable instructions to cause the at least one processor to determine comprise processor-readable instructions to cause the at least one processor to determine the Doppler shift of the first signal, and the non-transitory, processor-readable storage medium further comprises processor-readable instructions to cause the at least one processor to estimate a Doppler shift for a third signal of a second signal source that is separate from the first signal source.

Clause 32. The non-transitory, processor-readable storage medium of clause 28, further comprising processor-readable instructions to cause the at least one processor to measure the first signal and measuring the second signal, wherein the processor-readable instructions to cause the at least one processor to determine comprise processor-readable instructions to cause the at least one processor to determine whether the first phase of the first signal is consistent with the second phase of the second signal, and the non-transitory, processor-readable storage medium further comprises processor-readable instructions to cause the at least one processor to perform a mitigation action based on the first phase of the first signal being inconsistent with the second phase of the second signal.

Clause 33. The non-transitory, processor-readable storage medium of clause 28, further comprising processor-readable instructions to cause the at least one processor to measure the first signal, wherein the non-transitory, processor-readable storage medium further comprises processor-readable instructions to cause the at least one processor to measure the second signal differently than the measuring of the first signal.

Clause 34. The non-transitory, processor-readable storage medium of clause 33, wherein the processor-readable instructions to cause the at least one processor to measure the first signal comprise processor-readable instructions to cause the at least one processor to integrate for a first coherent integration time and the processor-readable instructions to cause the at least one processor to measure the second signal comprise processor-readable instructions to cause the at least one processor to integrate for a second coherent integration time that is shorter than the first coherent integration time.

Clause 35. The non-transitory, processor-readable storage medium of clause 28, further comprising processor-readable instructions to cause the at least one processor to measure the first signal and processor-readable instructions to cause the at least one processor to measure the second signal, wherein the processor-readable instructions to cause the at least one processor to determine comprise processor-readable instructions to cause the at least one processor to coherently combine a first correlation output of the first measurement result with a second correlation output of the second measurement result.

Clause 36. The non-transitory, processor-readable storage medium of clause 28, further comprising processor-readable instructions to cause the at least one processor to measure the first signal and processor-readable instructions to cause the at least one processor to measure the second signal, wherein the processor-readable instructions to cause the at least one processor to determine comprise processor-readable instructions to cause the at least one processor to non-coherently combine a first correlation output of the first measurement result with a second correlation output of the second measurement result.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, a list of items prefaced by “at least one of” or prefaced by “one or more of” indicates a disjunctive list such that, for example, a list of “at least one of A, B, or C,” or a list of “at least one of A, B, and C,” or a list of “one or more of A, B, or C”, or a list of “one or more of A, B, and C,” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of +20% or +10%, +5%, or +0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A method of using at least an attempt to measure a short-code-phase signal, the method comprising:
listening, at an apparatus, for a first signal from a first signal source to determine a first measurement result, the first signal having a first code sequence that is shorter than a second code sequence of a second signal from the first signal source; and
determining, at the apparatus and based on the first measurement result, at least one of a signal environment of the apparatus, an indication of time, a Doppler shift of the first signal, whether a first phase of the first signal is consistent with a second phase of the second signal, and a combination of the first measurement result and a second measurement result that comprises a measurement of the second signal.

2. The method of claim 1, further comprising:
entering, by the apparatus, a low-power mode;
waking up from the low-power mode to listen for the first signal; and
re-entering the low-power mode based on the first measurement result being a failure to measure the first signal within a threshold duration.

3. The method of claim 1, further comprising measuring the first signal at a plurality of times, wherein the determining comprises determining the indication of time for each of the plurality of times that the first signal is measured.

4. The method of claim 1, further comprising measuring the first signal, wherein the determining comprises determining the Doppler shift of the first signal, and the method further comprises estimating a Doppler shift for a third signal of a second signal source that is separate from the first signal source.

5. The method of claim 1, further comprising measuring the first signal and measuring the second signal, wherein the determining comprises determining whether the first phase of the first signal is consistent with the second phase of the second signal, and the method further comprises performing, at the apparatus, a mitigation action based on the first phase of the first signal being inconsistent with the second phase of the second signal.

6. The method of claim 1, further comprising measuring the first signal, wherein the method further comprises measuring the second signal differently than the measuring of the first signal.

7. The method of claim 6, wherein measuring the first signal comprises integrating for a first coherent integration time and measuring the second signal comprises integrating for a second coherent integration time that is shorter than the first coherent integration time.

8. The method of claim 1, further comprising measuring the first signal and measuring the second signal, wherein the determining comprises coherently combining a first correlation output of the first measurement result with a second correlation output of the second measurement result.

9. The method of claim 1, further comprising measuring the first signal and measuring the second signal, wherein the determining comprises non-coherently combining a first correlation output of the first measurement result with a second correlation output of the second measurement result.

10. An apparatus comprising:
at least one receiver configured to listen for a first signal from a first signal source, the first signal having a first code sequence that is shorter than a second code sequence of a second signal from the first signal source; and
at least one processor communicatively coupled to the at least one receiver and configured to:
determine a first measurement result based on the at least one receiver listening for the first signal; and
determine, based on the first measurement result, at least one of presence/absence of the first signal, an indication of time, a Doppler shift of the first signal, whether a first phase of the first signal is consistent with a second phase of the second signal, and a combination of the first measurement result and a second measurement result that comprises a measurement of the second signal.

11. The apparatus of claim 10, wherein the at least one processor is further configured to:
cause the apparatus to enter a low-power mode;
intermittently cause the apparatus to wake up from the low-power mode to listen for the first signal; and
cause the apparatus to re-enter the low-power mode based on the first measurement result being a failure to measure the first signal within a threshold duration.

12. The apparatus of claim 10, wherein the at least one processor is configured to measure the first signal at a plurality of times, and to determine the indication of time for each of the plurality of times that the first signal is measured.

13. The apparatus of claim 10, wherein the at least one processor is configured to measure the first signal, determine the Doppler shift of the first signal, and estimate a Doppler shift for a third signal of a second signal source that is separate from the first signal source.

14. The apparatus of claim 10, wherein the at least one receiver is configured to listen for the second signal from the first, and wherein the at least one processor is configured to:
measure the first signal;
measure the second signal;
determine whether the first phase of the first signal is consistent with the second phase of the second signal; and
perform a mitigation action based on the first phase of the first signal being inconsistent with the second phase of the second signal.

15. The apparatus of claim 10, wherein the at least one receiver is configured to listen for the second signal from the first, and wherein the at least one processor is configured to:
measure the first signal; and
measure the second signal differently than the first signal.

16. The apparatus of claim 15, wherein the at least one processor is configured to integrate the first signal for a first coherent integration time and to integrate the second signal for a second coherent integration time that is shorter than the first coherent integration time.

17. The apparatus of claim 10, wherein the at least one receiver is configured to listen for the second signal from the first, and wherein the at least one processor is configured to:
measure the first signal;
measure the second signal; and
coherently combine a first correlation output of the first measurement result with a second correlation output of the second measurement result.

18. The apparatus of claim 10, wherein the at least one receiver is configured to listen for the second signal from the first, and wherein the at least one processor is configured to:
measure the first signal;
measure the second signal; and
non-coherently combine a first correlation output of the first measurement result with a second correlation output of the second measurement result.

19. An apparatus comprising:
means for listening for a first signal from a first signal source to determine a first measurement result, the first signal having a first code sequence that is shorter than a second code sequence of a second signal from the first signal source; and
means for determining, based on the first measurement result, at least one of a signal environment of the apparatus, an indication of time, a Doppler shift of the first signal, whether a first phase of the first signal is consistent with a second phase of the second signal, and a combination of the first measurement result and a second measurement result that comprises a measurement of the second signal.

20. The apparatus of claim 19, further comprising:
means for entering, by the apparatus, a low-power mode;
means for waking up from the low-power mode to listen for the first signal; and
means for re-entering the low-power mode based on the first measurement result being a failure to measure the first signal within a threshold duration.
